(19) United States
(12) Patent Application Publication
(10) Pub. No.: US 2017/0316189 A1
(43) Pub. Date: Nov. 2, 2017

(54) OBJECT-BASED WATERMARKING

(71) Applicant: Verance Corporation, San Diego, CA (US)

(72) Inventor: Joseph M. Winograd, San Diego, CA (US)

(21) Appl. No.: 15/523,279

(22) PCT Filed: Oct. 31, 2014
(86) PCT No.: PCT/US2014/063536

§ 371 Date: Apr. 28, 2017

(51) Int. Cl. G06F 21/12; G06F 21/16; G06T 1/00

(52) U.S. Cl. CPC G06F 21/125; G06T 1/005; G06F 21/16; G06F 2221/0737

(57) ABSTRACT

Methods, devices, systems and computer program products are provided for embedding and detection of a watermark message to and from an object-based composite content. One exemplary method includes for embedding a watermark message in an object-based composite content includes designating a plurality of content objects for carrying the watermark message comprising one or more watermark symbols in the composite object-based content that is generated according to an object-based encoding scheme. The method also includes obtaining a mapping of each watermark symbol to a temporal or spatial position of one or more of the designated content objects in the composite content, and embedding each watermark symbol by including each of the one or more of the designated content objects in the composite content in conformance with the temporal or spatial relationship provided by the mapping.

### FIELD OF INVENTION

The present application generally relates to the field of content management. More particularly, the disclosed embodiments relate to embedding and detection of watermarks to and from an object-based content.

### BACKGROUND

This section is intended to provide a background or context to the disclosed embodiments that are recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Watermarks are substantially imperceptible signals embedded into a host content. The host content may be any one of audio, still image, video or any other content that may be stored on a physical medium or transmitted or broadcast from one point to another. Watermarks are designed to carry auxiliary information without substantially affecting fidelity of the host content, or without interfering with normal usage of the host content. For this reason, watermarks are sometimes used to carry out covert communications, where the emphasis is on hiding the very presence of the hidden signals. In addition, other widespread applications of watermarks include prevention of unauthorized usage (e.g., duplication, playing and dissemination) of copyrighted multi-media content, proof of ownership, authentication, tampering detection, content integrity verification, broadcast monitoring, transaction tracking, audience measurement, triggering of secondary activities such as interacting with software programs or hardware components, communicating auxiliary information about the content such as caption text, full title and artist name, or instructions on how to purchase the content, and the like. The above list of applications is not intended to be exhaustive, as many other present and future systems can benefit from co-channel transmission of main and auxiliary information.

With the advent of new content delivery and encoding techniques, improved watermark embedding and detection techniques may be needed to both manage the challenges presented by such new techniques, and to take advantage of the new beneficial features of those techniques.

### SUMMARY

The disclosed embodiments relate to methods, devices, systems and computer program products for embedding and detecting a watermark message to and from an object-based composite content. One aspect of the disclosed embodiments relates to a method for embedding a watermark message in an object-based composite content that includes designating a plurality of content objects for carrying the watermark message comprising one or more watermark symbols in the composite object-based content that is generated according to an object-based encoding scheme. The method also includes obtaining a mapping of each watermark symbol to a temporal or spatial position of one or more of the designated content objects in the composite content, and embedding each watermark symbol by including each of the one or more of the designated content objects in the composite content in conformance with the temporal or spatial relationship provided by the mapping.

In one exemplary embodiment, the mapping provides a mapping of a starting point of the one or more designated content objects for each of the watermark symbols. In another exemplary embodiment, the mapping provides a mapping of a relative temporal or spatial distance between two or more of the designated content objects for each of the watermark symbols. In still another exemplary embodiment, the mapping provides a mapping for each possible watermark symbol value to a distinct temporal or spatial position of one or more of the designated content objects. In another exemplary embodiment, designating the plurality of content objects for carrying the watermark message includes identifying the plurality of content objects that carry at least part of the watermark message, where the identified plurality of content objects are required for enabling detection of the embedded watermark message at a watermark detector device.

According to one exemplary embodiment, designating the plurality of content objects for carrying the watermark message includes embedding an identification watermark into each of the plurality of content objects that are used to carry at least part of the watermark message. Upon detection of the identification watermark at a watermark detector device, content objects that are used to carry at least part of the watermark messages are identified so as to enable detection of the watermark message based on the identified content objects and the mapping of each watermark symbol to the temporal or spatial position of one or more of the identified content objects. In one exemplary embodiment, the mapping is provided as a mapping table, while in another exemplary embodiment, the mapping is provided as an algorithm.

Another aspect of the disclosed embodiments relates to a method for embedding a watermark message comprising one or more watermark symbols in a content that is generated according to an object-based encoding scheme. The method includes identifying a plurality of content objects for carrying the watermark message in a composite object-based content. The method also includes, for each identified content object, generating at least one alternate version of the identified content object so as to allow all values of a watermark symbol to be represented by each of the identified content objects or an alternate version thereof. The method additionally includes embedding each watermark symbol by choosing one, but not both, of a particular content object or an alternate version of the particular content object, and including the chosen one of the content object or the alternate version in the composite content.

In one exemplary embodiment, the watermark symbols are binary symbols and choosing one, but not both, of the particular content object or the alternate version includes one, but not both, of: (a) choosing/g/; the particular content object to represent a binary value of zero and choosing the alternate version of the particular content object to represent a binary value of one; or (b) choosing the particular content object to represent a binary value of one and choosing the alternate version of the particular content object to represent a binary value of zero. In another exemplary embodiment, a first alternate version is generated by embedding a first watermark in the particular content object, and a second alternate object is generated by embedding a second watermark that is different from the first watermark in the particular content object.

Another aspect of the disclosed embodiments relates to a device that includes a processor, and a memory comprising program code. The program code when executed by the processor, causes the device to designate a plurality of content objects for carrying a watermark message comprising one or more watermark symbols in a composite object-based content that is generated according to an object-based encoding scheme. The program code when executed by the processor, causes the device to obtain a mapping of each watermark symbol to a temporal or spatial position of one or more of the designated content objects in the composite content, and to embed each watermark symbol by including each of the one or more of the designated content objects in the composite content in conformance with the temporal or spatial relationship provided by the mapping.

In one exemplary embodiment, the program code when executed by the processor, causes the device to designate the plurality of content objects for carrying the watermark message by at least in-part identification of the plurality of content objects that carry at least part of the watermark message, wherein the identified plurality of content objects are required for enabling detection of the embedded watermark message at a watermark detector device. In another exemplary embodiment, the program code when executed by the processor, causes the device to designate the plurality of content objects for carrying the watermark message by at least in-part embedding an identification watermark into each of the plurality of content objects that are used to carry at least part of the watermark message. Upon detection of the identification watermark at a watermark detector device, content objects that are used to carry at least part of the watermark message are identified so as to enable detection of the watermark message based on the identified content objects and the mapping of each watermark symbol to the temporal or spatial position of one or more of the identified content objects.

According to one exemplary bodiment, the memory includes a mapping table that provides the mapping. In another exemplary embodiment, the mapping is provided as an algorithm that is executed by the processor.

Another aspect of the disclosed embodiments relates to a device that includes a processor, and a memory comprising program code. The program code when executed by the processor, causes the device to identify a plurality of content objects for carrying a watermark message comprising one or more watermark symbols in a composite object-based content that is generated according to an object-based encoding scheme. The program code when executed by the processor, also causes the device to, for each identified content object, generate at least one alternate version of the identified content object so as to allow all values of a watermark symbol to be represented by each of the identified content objects or an alternate version thereof, and embed each water/mark symbol by choosing one, but not both, of a particular content object or an alternate version of the particular content object, and include the chosen one of the content object or the alternate version in the composite content.

According to one exemplary embodiment, the program code when executed by the processor, causes the device to generate a first alternate version by embedding a first watermark in the particular content object, and generate a second alternate object by embedding a second watermark that is different from the first watermark in the particular content object.

Another aspect of the disclosed embodiments relates to a computer program product, embodied on one or more non-transitory computer readable media. The computer program product includes program code for designating a plurality of content objects for carrying a watermark message comprising one or more watermark symbols in a composite object-based content that is generated according to an object-based encoding scheme, as well as program code for obtaining a mapping of each watermark symbol to a temporal or spatial position of one or more of the designated content objects in the composite content, and program code for embedding each watermark symbol by including each of the one or more of the designated content objects in the composite content in conformance with the temporal or spatial relationship provided by the mapping.

Another aspect of the disclosed embodiments relates to a computer program product, embodied on one Of more non-transitory computer readable media. The computer program product includes program code for identify a plurality of content objects for carrying a watermark message comprising one or more watermark symbols in a composite object-based content that is generated according to an object-based encoding scheme. The computer program product also includes program code for, for each identified content object, generating at least one alternate version of the identified content object so as to allow all values of a watermark symbol to be represented by each of the identified content objects or an alternate version thereof, as well as program code for embedding each watermark symbol by choosing one, but not both, of a particular content object or an alternate version of the particular content object, and including the chosen one of the content object or the alternate version in the composite content.

Another aspect of the disclosed embodiments relates to a method for detecting a watermark message from a composite content. The method includes receiving the composite content that includes the watermark message comprising one or more watermark symbols, the composite content having been generated according to an object-based encoding scheme, and obtaining a plurality of content objects, each of the plurality of content objects designated as including at least part of the watermark message that is embedded in the composite content. The method also includes obtaining a mapping of watermark symbols to temporal or spatial positions of the plurality of content objects in the composite content, where the mapping including a mapping of each watermark symbol value to a particular temporal or spatial position of one or more of the plurality of content objects. The method further includes using the mapping and the plurality of content objects to discern one or more watermark symbols of the watermark message included in the composite content based on the temporal or spatial positions of the plurality of content objects in the composite content.

In one exemplary embodiment, using the mapping and the plurality of content objects to discern the one or more watermark symbols of the watermark message includes: correlating a first of the plurality of content objects with the composite content to locate the position of the first of the plurality of content objects in the composite content, and using the mapping to determine the value of a first watermark symbol embedded in the composite content based on the temporal or spatial position of the first of the plurality of content objects in the composite content.

Another aspect of the disclosed embodiments relates to a method for detecting a watermark message from a composite content. This method includes receiving the composite content that includes the watermark message comprising one or more watermark symbols, the composite content having been generated according to an object-based encoding scheme and including a plurality of content objects. The method further includes detecting identification watermarks from the received composite content, each identification watermark identifying (a) a content object that is used to carry at least part of the embedded watermark message in the composite content, and (b) a temporal or a spatial position of the content object in the composite content. The method also includes obtaining a mapping of watermark symbols to temporal or spatial positions of the plurality of content objects in the composite content, the mapping including a mapping of each watermark symbol value to a particular temporal or spatial position of one or more of the plurality of content objects. The method additionally includes using the mapping to discern one or more watermark symbols of the watermark message included in the composite content based on the temporal or spatial positions of the identified content objects and the temporal or spatial positions of the identified content objects in the composite content.

In one exemplary embodiment, identifying the temporal or a spatial position of the content object in the composite content includes identifying a starting location of the content object in the composite content. In another exemplary embodiment, identifying the temporal or a spatial position of the content object in the composite content includes identifying a relative location of the of the content object with respect to another content object in the composite content. In still another exemplary embodiment, the identification information conveys information regarding a sequential order of watermark symbols of the watermark message.

Another aspect of the disclosed embodiments relates to a device that includes a processor, and a memory comprising program code. The program code when executed by the processor causes the device to receive a composite content, the composite content having been generated according to an object-based encoding scheme. The program code when executed by the processor also causes the device lo obtain a plurality of content objects, where each of the plurality of content objects is designated as including at least part of a watermark message comprising one or more watermark symbols embedded in the composite content. The program code when executed by the processor further causes the device to obtain a mapping of watermark symbols to temporal or spatial positions of the plurality of content objects in the composite content, where the mapping includes a mapping of each watermark symbol value to a particular temporal or spatial position of one or more of the plurality of content objects. The program code when executed by the processor further causes the device to discern the watermark symbols of the watermark message included in the composite content using the mapping and the plurality of content objects and based on the temporal or spatial positions of the plurality of content objects in the composite content.

in one exemplary embodiment, to discern the watermark symbols of the watermark message, the program code when executed by the processor causes the device to at least correlate a first of the plurality of content objects with the composite content to locate the position of the first of the plurality of content objects in the composite content; and use the mapping to determine the value of a first watermark symbol embedded in the composite content based on the temporal or spatial position of the first of the plurality of content objects in the composite content.

Another aspect of the disclosed embodiments relates to a device that includes a processor, and a memory comprising program code. The program code when executed by the processor causes the device to receive a composite content that includes a watermark message comprising one or more watermark symbols, the composite content having been generated according to an object-based encoding scheme and including a plurality of content objects. The program code when executed by the processor also causes the device to detect identification watermarks from the received composite content, where each identification watermark identifies (a) a content object that is used to carry at least part of the embedded watermark message in the composite content, and (h) a temporal or a spatial position of the content object in the composite content. The program code when executed by the processor additionally causes the device to obtain a flapping of watermark symbols to temporal or spatial positions of the plurality of content objects in the composite content, where the mapping includes a mapping of each watermark symbol value to a particular temporal or spatial position of one or More, of the plurality of content objects. The program code when executed by the processor further causes the device to use the mapping to discern the one or more watermark symbols of the watermark message included in the composite content based on the temporal or spatial positions of the identified content objects and the temporal or spatial positions of the identified content objects in the composite content.

In one exemplary embodiment, to identify the temporal or a spatial position of the content object in the composite content, the program code when executed by the processor causes the device to at least identify a starting location of the content object in the composite content. In another exemplary embodiment, to identify the temporal or a spatial position of the content object in the composite content, the program code when executed by the processor causes the device to at least identify a relative location of the of the content object with respect to another content object in the composite content.

Another aspect of the disclosed embodiments relates to a computer program product, embodied on one or More, non-transitory computer readable media. The computer program product includes program code for receiving the composite content that includes a watermark message comprising one or more watermark symbols, the composite content having been generated according to an object-based encoding scheme. The computer program product also includes program code for obtaining a plurality of content objects, each of the plurality of content objects designated as including at least part of the watermark message that is embedded in the composite content, and program code for obtaining a. mapping of watermark symbols to temporal or spatial positions of the plurality of content objects in the composite content, the mapping including a mapping of each watermark symbol value to a particular temporal or spatial position of one or more of the plurality of content objects. The computer program product also includes program code for using the mapping and the plurality of content objects to discern the one or more watermark symbols of the watermark message included in the composite content based on the temporal or spatial positions of the plurality of content objects in the composite content.

Another aspect of the disclosed embodiments relates to a computer program product, embodied on one or more non-transitory computer readable media. The computer program product includes program code for receiving the composite content that includes a watermark message comprising one or more watermark symbols, the composite content having been generated according to an object-based encoding scheme and including a plurality of content objects. The computer program product also includes program code for detecting identification watermarks from the received composite content, where each identification watermark identifies (a) a content object that is used to carry at least part of the embedded watermark message in the composite content, and (b) a temporal or a spatial position of the content object in the composite content. The computer program product also includes program code for obtaining a mapping of watermark symbols to temporal or spatial positions of the plurality of content objects in the composite content, where the mapping includes a mapping of each watermark symbol value to a particular temporal or spatial position of one or more of the plurality of content objects. The computer program product further includes program code for using the mapping to discern the one or more watermark symbols of the watermark message included in the composite content based on the temporal or spatial positions of the identified content objects and the temporal or spatial positions of the identified content objects in the composite content.

Another aspect of the disclosed embodiments relates to a device that is implemented at least partially in hardware. The device includes a content object selector to receive a plurality of content objects and to designate a subset of the plurality of content objects for carrying a watermark message comprising one or more watermark symbols. The device further includes a watermark symbol mapping generator to obtain a mapping of each watermark symbol to a temporal or spatial position of one or more of the designated content objects in a composite object-based content that is generated according to an object-based encoding scheme, as well as a watermark symbol generator to generate the plurality of watermark symbols for embedding into the composite object-based content. The device additionally includes a renderer coupled to the content object selector, the watermark symbol mapping generator and the watermark symbol generator to embed the watermark symbols provided by the watermark symbol generator by including each of the one or more of the designated content objects identified by the content object selector in the composite object-based content output by the renderer in conformance with the temporal or spatial relationship provided by the watermark symbol mapping generator.

Another aspect of the disclosed embodiments relates to a device, implemented at least partially in hardware, that includes a content object selector to receive a plurality of content objects and to designate a subset of the plurality of content objects for carrying a watermark message comprising one or more watermark symbols. The device also includes a watermark symbol generator to generate the plurality of watermark symbols for embedding into the composite object-based content, and a watermark embedder coupled to the content object selector to receive each of the designated content objects and to generate at least one alternate version of the designated content object so as to allow all values of a watermark symbol to be represented by each of the identified content objects or an alternate version thereof. The device also includes a renderer coupled to the watermark embedder, the watermark symbol mapping generator and the watermark symbol generator to embed the watermark symbols provided by the watermark symbol generator by choosing one, but not both, of designated content objects or alternate versions thereof provided by the watermark embedder in the composite object-based content output by the renderer in conformance with the temporal or spatial relationship provided by the watermark symbol mapping generator.

Another aspect of the disclosed embodiments relates to a device, implemented at least partially in hardware, that includes a receiver to receive (a) a composite content that includes a watermark message comprising one or more watermark symbols, the composite content having been generated according to an object-based encoding scheme, (b) a plurality of content objects, each of the plurality of content objects designated as including at least part of the watermark message that is embedded in the composite content, and (c) a mapping of watermark symbols to temporal or spatial positions of the plurality of content objects in the composite content, the mapping including a mapping of each watermark symbol value to a particular temporal or spatial position of one or more of the plurality of content objects. The device also includes a content object identifier coupled to the receiver to use the mapping and the plurality of content objects to identify temporal or spatial positions of the plurality of content objects in the received composite content. The device further includes a watermark symbol detector coupled to the content object identifier to discern one or more watermark symbols of the watermark message included in the composite content based on the temporal or spatial positions of the plurality of content objects in the composite content in accordance with the mapping.

Another aspect of the disclosed embodiments relates to a device, implemented at least partially in hardware, that includes a receiver to receive (a) a composite content that includes a watermark message comprising one or more watermark symbols, the composite content having been generated according to an object-based encoding scheme and including a plurality of content objects, and (b) a mapping of watermark symbols to temporal or spatial positions of the plurality of content objects in the composite content, the mapping including a mapping of each watermark symbol value to a particular temporal or spatial position of one or more of the plurality of content objects. The device also includes an identification watermark extractor coupled to the receiver to detect identification watermarks from the received composite content, each identification watermark identifying (a) a content object that is used to carry at least part of the embedded watermark message in the composite content, and (b) a temporal or a spatial position of the content object in the composite content. The device further includes a watermark symbol detector coupled to the content object identifier and to the receiver to discern one or more watermark symbols of the watermark message included in the composite content based on the temporal or spatial positions of the plurality of content objects in the composite content in accordance with the mapping.

Another aspect of the disclosed embodiments relates to a system for embedding and detection of a watermark message, that includes an embedder device and a detector device. The embedder device includes a content object selector to receive a plurality of content objects and to designate a subset of the plurality of content objects for carrying a watermark message comprising one or more watermark symbols. The embedder device further includes a watermark symbol mapping generator to obtain a mapping of each watermark symbol to a temporal or spatial position of one or more of the designated content objects in a composite object-based content that is generated according to an object-based encoding scheme, as well as a watermark symbol generator to generate the plurality of watermark symbols for embedding into the composite object-based content. The embedder device additionally includes a renderer coupled to the content object selector, the watermark symbol mapping generator and the watermark symbol generator to embed the watermark symbols provided by the watermark symbol generator by including each of the one or more of the designated content objects identified by the content object selector in the composite object--based content output by the renderer in conformance with the temporal or spatial relationship provided by the watermark symbol mapping generator. The detector device can that include a receiver to receive (a) the composite content that includes the watermark message comprising one or more watermark symbols, the composite content having been generated according to an object-based encoding scheme, (b) a plurality of content objects, each of the plurality of content objects designated as including at least part of the water/t mark message that is embedded in the composite content, and (c) a mapping of watermark symbols to temporal or spatial positions of the plurality of content objects in the composite content, the mapping including a mapping of each watermark symbol value to a particular temporal or spatial position of one or more of the plurality of content objects. The detector device also includes a content object identifier coupled to the receiver to use the mapping and the plurality of content objects to identify temporal or spatial positions of the plurality of content objects in the received composite content. The detector device further includes a watermark symbol detector coupled to the content object identifier to discern one or more watermark symbols of the watermark message included in the composite content based on the temporal or spatial positions of the plurality of content objects in the composite content in accordance with the mapping.

It should be noted that any of the disclosed embodiments may be combined with other disclosed embodiments of the present application.

### BRIEF DESCRIPTION OF THE DRAWINGS

FIG. 1 illustrates a device that can be used for embedding of a watermark message in an object-based content in accordance with an exemplary embodiment.

FIG. 2 illustrates a set of operations that may be carried out to embed a watermark message in an object-based content in accordance with an exemplary embodiment.

FIG. 3 illustrates another set of operations that may be carried out to embed a watermark message in an object-based content in accordance with an exemplary embodiment

FIG. 4 illustrates a set of operations that may be carried out to detect a watermark message from an object-based content in accordance with an exemplary embodiment.

FIG. 5 illustrates another set of operations that may be carried out to detect a watermark message from an object-based content in accordance with an exemplary embodiment.

FIG. 6 illustrates a device that can be used for detecting a watermark message from a composite object-based content in accordance with an exemplary embodiment.

FIG. 7 illustrates a block diagram of a device within which various disclosed embodiments may be implemented.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

Watermarks can be embedded into a host content using a variety of watermark embedding techniques by, for example, manipulating the least significant bits of the host signal in time or frequency domains, insertion of watermarks with an independent carrier signal using spread spectrum, phase, amplitude or frequency modulation techniques, and insertion of watermarks using a host-dependent carrier signal such as feature modulation and informed-embedding techniques. Most embedding techniques utilize psycho-visual or psycho-acoustical (or both) analysis of the host content to determine optimal locations and amplitudes for the insertion of watermarks. This analysis typically identifies the degree to which the host signal can hide or mask the embedded watermarks as perceived by humans.

In the disclosed embodiments, the term “watermark message” is used to convey a particular value or message that is embodied in a content. Typically, a watermark message is embedded as a sequence of symbols that form a watermark packet. A watermark packet can include a starting header (often used to facilitate identification of a watermark packet starting location), a payload (e.g., a series of watermark symbols that can include a particular watermark value, as well as parity or redundancy bits that are used for the purpose of error detection and/or error correction) and sometimes an ending header (often used to facilitate identification of a watermark packet ending location). Packet formation techniques may be used to properly format the symbols of the watermark packet. For example, the watermark symbols of a watermark packet may be mapped to certain bit patterns that provide improved performance characteristics, such as an improved signal-to-noise ratio, l improved robustness to synchronization errors, etc. In some instances, the watermark packet symbols are scrambled or encrypted to provide an added level of data security. These and other packet formation techniques which may be used to produce a watermark packet, ultimately generate a series of watermark symbols (e.g., bits) that are embedded in a content.

An embedded host content is often stored and/or transmitted to another location using a variety of storage and/or transmission channels. These channels are characterized by inherent noise and distortions, such as errors due to scratches and fingerprints that contaminate data on optical media, noise in over-the-air broadcasts of audio-visual content, packet drops in streaming of multi-media content over the Internet or from a media server, and the like. Additional impairments that can affect fidelity of the embedded watermarks may be due to various signal processing operations that are typically performed on multimedia content such as lossy compression, scaling, rotation, analog-to-digital conversion and the like. In most digital watermarking applications, the embedded watermarks must be able to maintain their integrity under such noise and distortion conditions.

When designing a watermarking system several often competing factors are considered to reach the proper balance between transparency (imperceptibility) of embedded watermarks, robustness of embedded watermarks (i.e., the watermark's ability to withstand intentional and unintentional signal distortions) and security requirements of the system (i.e., the extent to which embedded watermarks can evade detection, deletion and/or manipulation by unauthorized parties). Such a balancing act must be carried out while limiting the average and/or maximum number of processing operations (i.e., the processing load) and memory usage below particular levels that are often imposed for practical software and/or hardware implementations of watermark embedder and/or a watermark extractor.

One consideration in designing a watermarking system is the watermark payload capacity. This requirement depends on the specific application of the watermarking system. Typical applications range from requiring the detection of only the presence of the watermarks (i.e., requiring single-state watermarks) to requiring a few tens of bits of auxiliary information per second. In the latter case, the embedded bits may be used to carry identification and timing information such as serial numbers and timestamps, metadata, such as captions, artist names, purchasing information, etc.

Another factor in designing practical watermarking systems is computational costs of the embedding and/or extraction units. This factor becomes increasingly important for consumer electronic devices or software utilities that must be implemented with a limited silicon real estate or computational requirements. This factor can be strongly related to the intended use of the watermarking systems. For example, watermarks for forensic tracing of piracy channels, such as those that embed different codes in each copy of content distributed over the Internet, require a simple embedder and may tolerate a complex and costly forensic extractor. On the other hand, copy-control systems designed to prevent unauthorized access to multi-media content in consumer electronic devices, for example, may tolerate a sophisticated embedder but require a simple and efficient extractor.

Yet another important factor in designing a watermarking system is the probability of false watermark detections. A false watermark can be produced when a watermark is detected from an unmarked content, or may be due to the detection of a watermark value that is different from the originally embedded watermark value. The desired levels of false watermark detection can also vary depending on the intended application of the watermarking system.

Another important factor that impacts the overall performance of the watermarking system is the selection of a particular technology for water mark embedding and extraction. In particular, each watermark embedding and/or extraction techniques may have its own advantages and disadvantages in terms of its robustness against attacks and impairments, computational complexity, transparency of watermarks and other factors.

The security of embedded watermarks is another aspect of watermarking systems. In certain applications, such as proof of ownership, source authentication, piracy tracing, access control of copyrighted content, it is essential that embedded watermarks resist intentional manipulations aimed at detecting the presence of watermarks, deciphering the data carried by those watermarks, modifying or inserting illegal values (forgery), and/or removing the embedded watermarks.

With the proliferation of different types of content encoding and delivery systems, watermarking systems can benefit (and suffer) from the specific features of such content encoding and delivery techniques. In particular, object-based encodings, which were previously widely used in content production, are increasingly being used for distribution of audio and audiovisual content to end devices for use in rendering and display to an audience. Examples of object-based encodings intended for audio and audiovisual content distribution include MPEG-4 and Dolby Atmos, Audio or audiovisual content produced in an object-based scheme is a composite of individually recorded or created elements (or “objects”). Examples of audio objects include distinct recordings of individual instruments, samples or performances used in a recorded song or separate recordings of dialog, music, sound effects, and ambient sounds (the reproduction of everyday sound effects that are added to film, video, and other media in post-production to enhance audio quality is referred to as “Foley”). Examples of video objects are title overlays, logos, visual effects or, in the case of animated works, all elements of the video.

Embedding watermarks in composite content that is generated front multiple objects poses several challenges including synchronization of individual watermarks and efficiency of watermark insertion. One approach to the use of watermarking technology in conjunction with object-based encodings includes applying synchronized, common watermarks to a substantial subset of objects (e.g., the “bed” channels in Dolby Atmos) and enforcing a constraint that the synchrony of these objects be fixed while ignoring the other objects and allowing them serve as “noise” in the watermark channel. Another approach is to apply synchronized common watermarks to all objects and enforcing a constraint that the synchrony of all objects be fixed.

The disclosed embodiments provide a more advanced method of watermarking object-based content in which distinct objects are independently modified. Alternatively, or additionally, the manner in which objects are composited (e.g. synchronization of objects and/or watermarks embedded in the objects) can be modified such that watermark information can be advantageously recovered from the composited content.

Object-based watermarking is of particular advantage in the context of modern object-based content encoding schemes because (a) such encoding schemes already require that content be available as individual objects, and (b) such encoding schemes already require that substantial logic complexity exist at the rendering and display device.

One exemplary embodiment employs modifications to the temporal or spatial relationship of composited objects to encode watermark information. That is, such a watermark is manifested in the temporal or spatial relationship of the objects rather than embedding a foreign signal into the objects. The watermark can be recovered by identifying the objects and measuring their relationship to one another. Note that if such modifications are used as the sole means for carrying watermark information, such detection cannot be blind (i.e., the detection of the watermark requires the presence of content objects at the detector). Note also that with respect to audio, temporal relationship of the objects is readily understood as the distance (in time) among the various objects, whereas spatial relationship of the objects can include the location of an object in the sound field.

For the above exemplary embodiment, a convention is provided to (a) identify objects that comprise the message and (b) map object relationship to watermark data. Objects that comprise the message can be identified in the object-based encoding with a metadata flag that indicates that the object is used to as a watermark component. The object relationship mapping can be a predefined function (e.g., a formula) that maps temporal distances between the starting time (e.g., for audio) or spatial distances (e.g., for video) to a binary value in a watermark message (e.g. using a quantization grid).

Table 1 provides an exemplary mapping of identified objects I through ‘n’ to binary watermark symbols. In the example of Table 1, Objects 1 to n can represent n audio objects that have been designated (e.g., tagged) as being used in forming the watermark message. With respect to Object 1, if this object starts in the range 0 to 0.5 seconds within the content's timeline, it represents a zero-valued watermark symbol, and if it appears in the range 0.5 to 1 second, it represents a one-valued watermark symbol. Similar mapping to either a “0” or a “1” symbol is provided for Objects 2 to a in Table 1.

TABLE 1
Exemplary Mapping of Objects to Watermark Symbols

| | Starting Time (in Seconds) | |
|---|---|---|
| | “0” Symbol | “1” Symbol |
| Object 1 | 0 to 0.5 | 0.5 to 1 |
| Object 2 | 1 to 1.5 | 1.5 to 7 |
| Object 3 | 2 to 3.5 | 3.5 to 4 |
| Object 4 | 3 to 4 | 4 to 5 |
| . . . | . . . | . . . |
| Object n | 7175 to 7176 | 7176 to 7178 |

It should be noted that for simplicity, Table 1only illustrates a mapping of objects to binary symbols based on their temporal starting points. It is understood, however, that analogous mappings can be provided for non-binary symbols, as well as mappings based on spatial starting points of visual or audible objects. It is further understood that mappings of watermarks symbols can be constructed based on other temporal or spatial relationships, such as based on relative distances among the various designated objects. That is, temporal and/or spatial distances between the designated objects can be mapped to watermark symbols. Mapping of watermark symbol values can be provided to a watermark detector in the form of a table that can be stored in memory, or an algorithm (e.g., as program code) that allows formulaic determination of the mapping when such an algorithm is executed by a processor.

To embody a watermark message in a composite content comprised of multiple objects, an object renderer is provided with a watermark message (e.g, a particular sequence of bits) that is to be embedded in the content. The object renderer adjusts the object relationship for the objects identified as comprising the watermark message in accordance with symbols of the message based on the provided mapping. The mapping can also include the proper ordering of the objects. In the simplest case, successive objects (e.g., Objects 1 through 4 of Table 1 in that order) represent successive symbols of a watermark message. In other embodiments, a particular order (or even a randomly generated ordering of identified objects) can be used for representing successive watermark symbols. The object renderer thus produces a watermarked composite content where the objects identified as comprising the watermark message exhibit the relationship which indicates the watermark message in accordance with the defined relationship mapping. Such watermarks cannot be detected blindly. Since the watermark message is conveyed through many content objects that are now part of a composite content, such content objects are not typically identifiable at a watermark detector unless the detector is provided with those objects that form the watermark. To enable the detection of embedded watermark, the detector, in addition to the composite content, may be provided with, for example, content object files (e.g., particular sound effects throughout the composite content) that were used during watermark embedding. The received composite content can be correlated, or otherwise processed, with each of the provided content object files to identify the positions of those objects within the composite content. Once the objects are located, the mapping relationship can be used to discern the value of the embedded watermark symbols.

In another embodiment, modified versions of one or more objects are provided, where each modified version represents an alternate version of the object that can be selected for generating the composite content. The object renderer provides a composite content by selecting one of the alternate versions for each of the identified objects such that watermark information is carried by the selected objects or combination thereof. For example, in a binary marking system, each watermark symbol can be selected from one of two alternatives In some exemplary embodiments, the alternate versions of the objects are produced by embedding a distinct identifying watermark into each alternate version of the object. For example, multiple versions of selected objects can be produced, where each version carries a different watermark symbol or message. The watermark may be embedded using any of the known watermark embedding techniques such as spread spectrum watermarking, autocorrelation modulation, feature modulation and others. In a simple binary watermarking scheme, two versions of an object are carried: one that is the object without modification (e.g., representing a binary value of ‘0’), and the other is the object with any embedded watermark value (e.g., representing an embedded value of ‘1). In this simple scheme, the presence or absence of a watermark conveys a binary signal. In another variation still two alternate versions of the content object are generated: one embedded with a symbol value “0” and the other with a symbol value “1”. The object renderer selects one version of the object from among the multiple available versions to include in the rendering based on the watermark message data that it desires to embed. This can be repeated throughout the content to communicate an arbitrary watermark message. When watermark embedding is used to create the alternate versions, detection of watermarks can be done in a blind fashion, without a need to separately receive the content objects that participated in conveying the watermark message.

In other variations of the above described embodiments, the alternate versions of each object can be produced by modifying the object in an artistically appealing or non-objectional way. For example, a first version of an object can depict a person with a closed fist, whereas a second version of the object can depict that person with a partially closed fist. The detection of watermarks from such composite content typically requires a non-blind detection scheme, where alternate content objects must be provided to the watermark detector.

It should be noted that according to the disclosed embodiments, it is not necessary that all objects participate in content marking. Thus only a limited number of objects in the composite content may be designated or used for conveying a watermark message.

In another exemplary embodiment, distinct identifying watermarks (also referred to herein as identification watermarks) are applied to multiple individual objects and modifications to the temporal or spatial relationship of composited objects are employed to encode watermark information. The watermark information can be recovered by detecting the relationship between the identifying watermarks in the composite signal containing the multiple individual objects. In this approach, the objects are embedded with a watermark but there is only one version of each object. The embedding of a watermark message is performed by compositing the watermarked objects according to a particular relationship with respect to one another according to a mapping function or a mapping table (the example in Table 1illustrates a simplified version such a mapping table). According to this embodiment, the embedded watermarks signal that a particular object is used to convey a watermark message; however, it is still the relationship between the objects that encodes a particular value of the watermark messages. When detecting the embedded watermarks, the watermark objects are identified and used by the detector for the purpose of automatically locating the embedded objects. Once the embedded objects are located, their predefined relationship can also be automatically determined in order to determine the watermark message in accordance with the defined relationship mapping. The presence of the watermarks in the objects enable blind detection. For example, the relationship between the starting locations of a first detected watermark and a second detected watermark can be used to discern an embedded watermark (e.g., bit) value based on a predefined mapping.

In some variations of the above embodiments, it suffices to encode a single identification watermark in each content object and rely on the natural sequence of content objects in the composite content in conjunction with the mapping table or mapping function to signal the arrangement order of the watermark symbols. In some variations, the identification watermarks can also convey the arrangement order of the content objects. For instance, using the simple example of Table 1, the payload of the identification watermark can include a common value that remains the same for all content objects and a counter value that increments by 1 for each successive content object that is embedded with the identification watermark. In other variations each content object can be embedded with a unique identification watermark that is produced in a random or pseudo-random fashion.

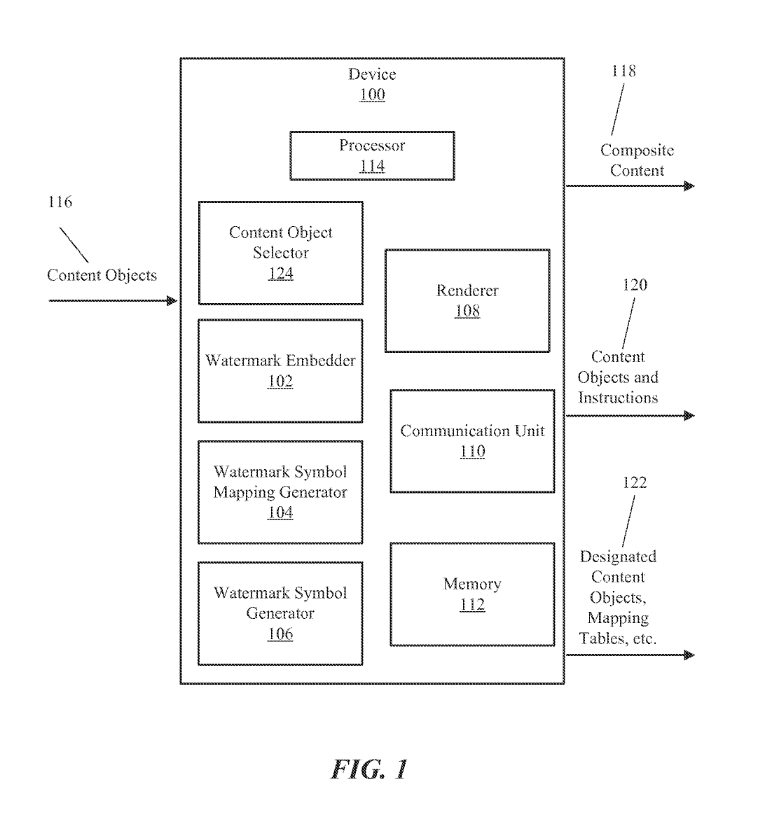

FIG. 1 illustrates a device 100 that can be used for embedding of a watermark message in an object-based content in accordance with an exemplary embodiment. The device 100 can include a processor 114 that performs various operations including management of data and information flow among different components of the device 100 and between the device and one or more external devices. The device 100 also includes a memory 112, which can be used for storage of content, information, data, program code and any other information that requires storage or buffering at the device 100. While only one memory 112 is shown, the device 100 can include more than one memory such as a hard disk, RAM, ROM, optical storage, magnetic storage and other types of volatile or non-volatile storage devices.

The communication unit 110 allows the device 100 to send or receive data, information and other signals to and from other devices, or other components. The communication unit 110 may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. The processor 114 and memory 112 can be coupled to each other and to alt other components of the device 100. In some embodiments, the processor 114 can initialize the various components of the device 100, load or configure those components with operating parameters, or program codes, or logic gate configurations and/or facilitate communication of data and other information among those components.

Referring again to FIG. 1, the device 100 also includes a content object selector 124 that selects and/or designates sonic of the content objects 116 that are provided to the device 100 for use in conveying a watermark message in the composite content. The content object selector 124 can, for example, be coupled to a receiver of the device 100 that receives the content objects 116. The receiver is not explicitly shown in FIG. 1 but can be implemented as part of the communication unit 110, or as a separate component coupled to the communication unit 110. The selected or designated content objects output by the content object selector 124 can be provided to a watermark embedder 102 that embeds watermark symbols into the designated content objects. In some embodiments, the watermark embedder 102 can be coupled to a receiver of the device 100 that receives the content objects 116, as well as to the content object selector 124 that provides an indication to the watermark embedder 102 as to which of the received content objects must be embedded with watermarks. The watermark embedder 102 may also be used to generate alternate versions of content objects by embedding distinct watermark values in each of the alternate versions of the designated content objects. The watermark embedder 102 can also include the proper circuitry or logic to form watermark symbols and watermark packets according to the appropriate packet generation techniques.

In some embodiments, a watermark symbol generator 106 can be implemented as a separate component to generate a watermark packet and the constituent watermark symbols. Such a watermark symbol generator 106 can be coupled to an input of the device 100 or can otherwise receive a code and/or a request for embedding a particular watermark message in the content. For example, the watermark symbol generator 106 can receive a particular code that identifies a unique transaction (e.g., a particular transaction identifying a user's purchase of the content). The watermark symbol generator 106 can then apply the proper packet encoding techniques (e.g, add of error correction codes, synchronization headers, perform channel coding, scrambling, encryption, etc.) to generate the appropriate watermark symbols for embedding into the content. The watermark symbol generator 106 can be coupled to the renderer 108 to provide the watermark symbols to be included in the composite content.

The watermark symbol mapping generator 104 provides a mapping of watermark symbols to temporal or spatial positions of the content objects. In some embodiments, such a mapping may be generated outside of the device 100, communicated to the device 100 and stored in memory 112. In such a case, the watermark symbol mapping generator 104 may retrieve the mapping from the memory and provide the mapping in the proper format at its output. The watermark embedder 102 and one or both of the watermark symbol mapping generator 104 and watermark symbols generator 106 are coupled to the renderer 108 that combines the content objects to produce a composite content 118 with a watermark message embedded therein. In some embodiments, the device 100 further produces content objects and instructions 120 which can be used by another component or device to generate the composite content. The device 100 can also generate an output 122 that includes the content objects designated as being used to convey the watermark symbols and mappings. The output 122 can be provided to a corresponding detector to enable the detection of watermark messages that are embedded in a composite content.

It should be noted that in some embodiments, the device 100 may include additional or fewer components, as needed to carry out various watermark embedding and content generation operations. For example, in some embodiments where the water mark message is conveyed through compositing the designated content objects in accordance with a predefined relationship, the device 100 may not include a watermark embedder 102 for embedding a watermark signal into the content objects. It should also be noted that the device 100 may be a standalone device, or may be implemented as part of another device, such as a content handling device capable of receiving a content. Examples of a content handling device include media players, television sets, and handheld devices such as smart phones, tablets, or laptops.

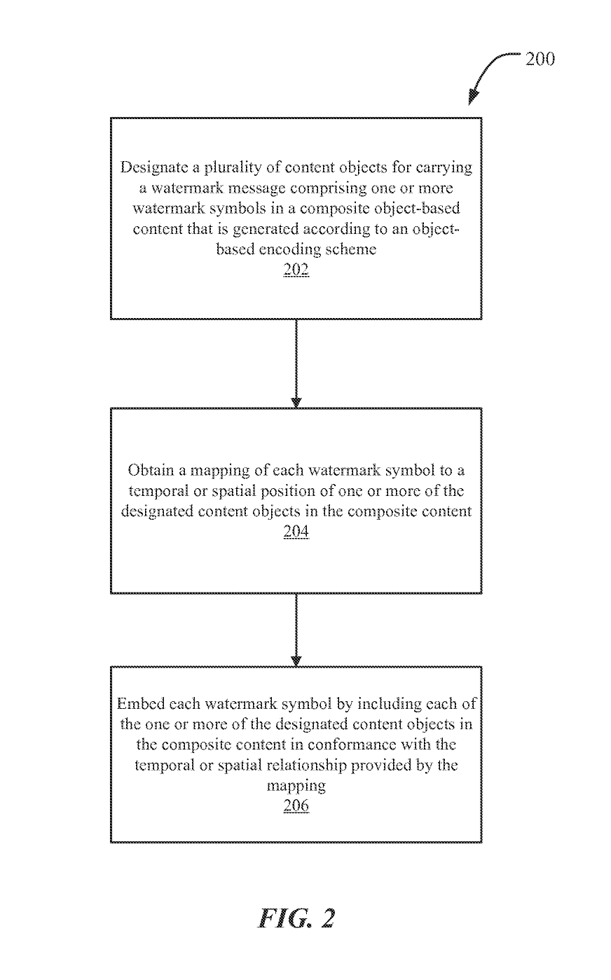

FIG. 2 illustrates a set of operations 200 that may be carried out to embed a watermark message in an object-based content in accordance with an exemplary embodiment. At 202, a plurality of content objects are designated for carrying a watermark message comprising one or more watermark symbols in a composite object-based content. The composite content is generated according to an object-based encoding scheme. At 204, a mapping of each watermark symbol to a temporal or spatial position of one or more of the designated content objects in the composite content is obtained. At 206, each watermark symbol is embedded by including each of the one or more of the designated content objects in the composite content in conformance with the temporal or spatial relationship provided by the mapping.

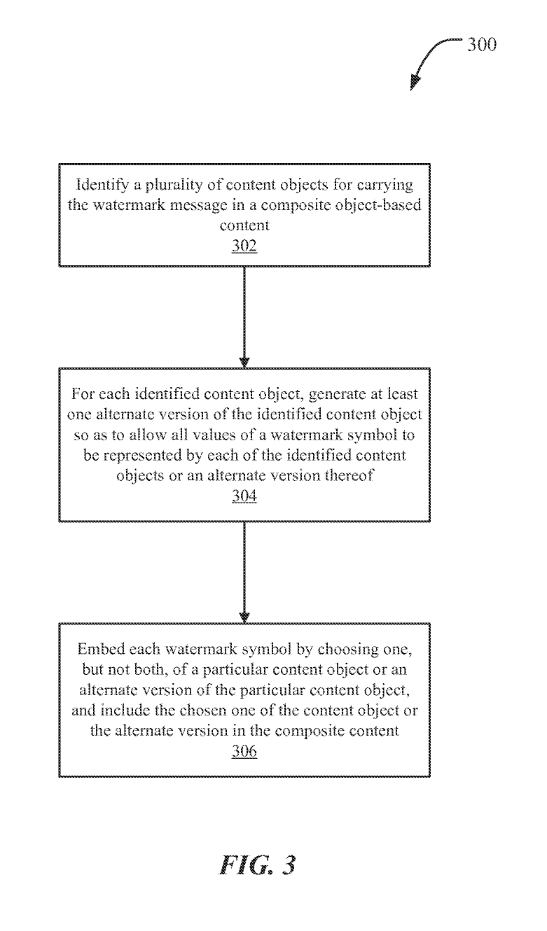

FIG. 3 illustrates another set of operations 300 that may be carried out to embed a watermark message in an object-based content in accordance with an exemplary embodiment. At 302, a plurality of content objects for carrying the watermark message in a composite object-based content are identified. At 304, for each identified content object, at least one alternate version of the identified content object is generated so as to allow all values of a watermark symbol to be represented by each of the identified content objects or an alternate version thereof. At 306, each watermark symbol is embedded by choosing one, but not both, of a particular content object or an alternate version of the particular content object, and the chosen one of the content object or the alternate version is included in the composite content.

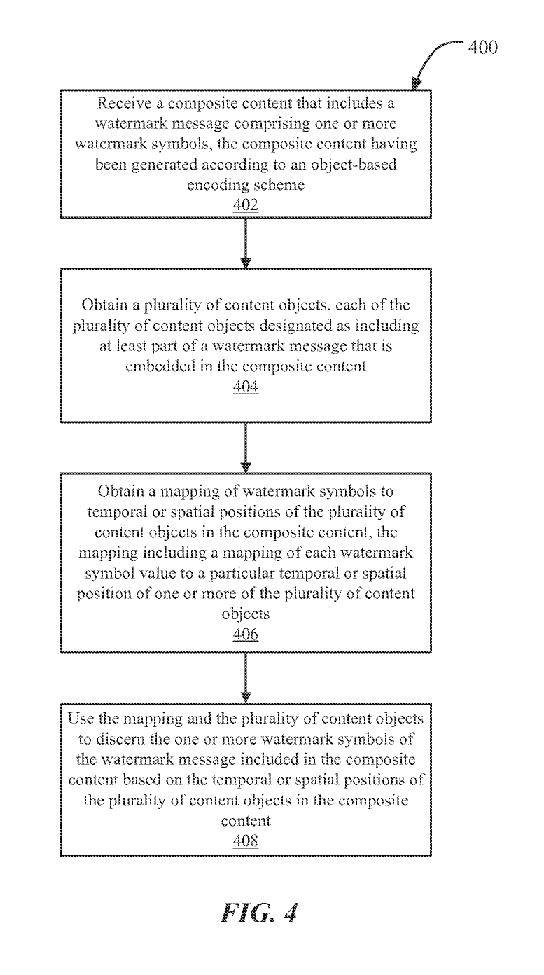

FIG. 4 illustrates a set of operations 400 that may be carried out to detect a watermark message from an object-based content in accordance with an exemplary embodiment. At 402, a composite content is received that includes a watermark message comprising one or more watermark symbols, the composite content having been generated according to an object-based encoding scheme. At 404, a plurality of content objects are obtained. Each of the plurality of content objects is designated as including at least part of a watermark message that is embedded in the composite content. At 406, a mapping of watermark symbols to temporal or spatial positions of the plurality of content objects in the composite content is obtained. The mapping includes a mapping of each watermark symbol value to a particular temporal or spatial position of one or more of the plurality of content objects. At 408, the mapping and the plurality of content objects are used to discern one or more watermark symbols of the watermark message included in the composite content based on the temporal or spatial positions of the plurality of content objects in the composite content. The operations 400 of FIG. 4 provide a non-blind detection scheme since the objects used for carrying the watermark message, as well as the composite content, are both used to detect the embedded watermark message from the composite content. The received content objects, however, typically form a smaller subset of all objects used in the composite content and, therefore, do not typically result in doubling of the required transmission bandwidth.

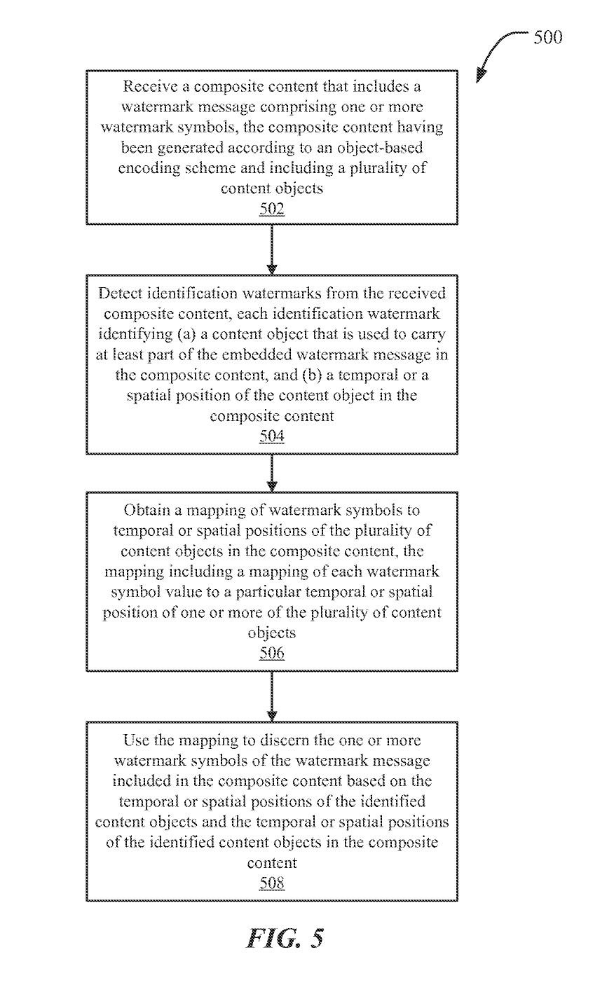

FIG. 5 illustrates another set of operations 500 that may be carried out to detect a watermark message from an object-based content in accordance with an exemplary embodiment. At 502, a composite content that includes a watermark message comprising one or more watermark symbols, the composite content having been generated according to an object-based encoding scheme and including a plurality of content objects. At 504, identification watermarks are detected from the received composite content. Each identification watermark identifies (a) a content object that is used to carry at least part of the embedded watermark message in the composite content, and (b) a temporal or a spatial position of the content object in the composite content. At 506, a mapping of watermark symbols to temporal or spatial positions of the plurality of content objects in the composite content is obtained. The mapping includes a mapping of each watermark symbol value to a particular temporal or spatial position of one or more of the plurality of content objects. At 508, the mapping is used to discern one or more watermark symbols of the watermark message included in the composite content based on the temporal or spatial positions of the identified content objects and the temporal or spatial positions of the identified content objects in the composite content. The operations 500 of FIG. 5 provide a blind detection scheme since the objects used for carrying the watermark message are not provided to the detector to detect the embedded watermark message.

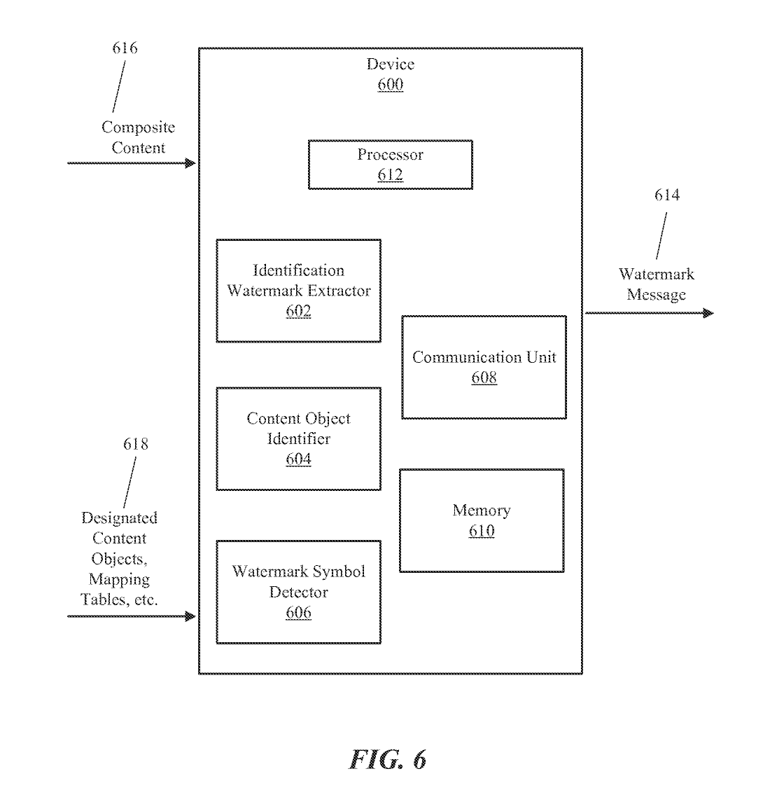

FIG. 6 illustrates a device 600 that can be used for detecting a watermark message from a composite object-based content in accordance with an exemplary embodiment. The device 600 can include a processor 612 that performs various operations including management of data and information flow among different components of the device 600 and between the device and one or more external devices. The device 600 also includes a memory 610, which can be used for storage of content, information, data, program code and any other information that requires storage or buffering at the device 600. While only one memory 610 is shown, the device 600 can include more than one memory such as a hard disk, RAM, ROM, optical storage, magnetic storage and other types of volatile or non-volatile storage devices.

The communication unit 608 allows the device to send or receive data, information and other signals to and from other devices, or other components. The communication unit 608 may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. The processor 612 and memory 610 can be coupled to each other and to all other components of the device 600. In some embodiments, the processor 612 can initialize the various components of the device 600, load or configure those components with operating parameters, or program codes, or logic gate configurations and/or facilitate communication of data and other information among those components.

The device 600 also includes an identification watermark extractor 602 that is coupled to a receiver 600 of the device 600 that receives the composite content 616. The receiver is not explicitly shown in FIG. 6 but can be implemented as part of the communication unit 608, or as a separate component coupled to the communication 608. The identification watermark extractor 602 extracts identification watermarks from the composite content 616, thereby identifying the content objects that are used to carry at least part of the watermark message, as well as their temporal or spatial locations in the composite content 616.

In some embodiments where identification watermarks are not used, content objects are identified by the content object identifier 604. For example, the content object identifier 604 can be coupled to a receiver that receives the designated content objects and mapping tables 618. The content object identifier 604 can process the received designated content objects to determine and identify temporal or spatial positions of the corresponding content objects in the composite content. The device 600 also includes a watermark symbol detector 606 that uses the mapping table and the output of either or both of the identification watermark extractor 602 and watermark symbol detector 606 to discern watermark symbols that are embedded in the composite content 616 based on the mapping. The detected watermark message 614 is then output from the device 600.

In some embodiments, the mapping may be transmitted to the device 600 and stored in memory 610 prior to the reception of the embedded composite content. In other embodiments, the composite content and the mapping may be provided at substantially the same time (e.g., as a single transmission stream or file, or as separate transmission streams or files) to the device 600. Further, it is understood that the content, mapping data or other information received at the device 600 may be stored (or buffered) at a memory component (e.g., memory 610) prior to, during, or after, usage or processing by various components of the device 600.

The device 600 may include additional or fewer components as needed to carry out watermark detection from a composite object-based content. The device 600 may be a standalone device, or may be implemented as part of another device, such as a content handling device capable of receiving a content.

Some exemplary applications of the disclosed embodiments include forensic marking of video or audio in a professional or consumer playback system to enable tracing unauthorized copies to their source. In such an application, each content that is provided (or consumed) by an authorized user or an authorized device includes a unique identifying watermark that allows such content (or the transaction that provides the content to the authorized user or device) to be uniquely identified. Any of the disclosed embodiments that uses a blind or non-blind watermark detection scheme can be used for this.

Another exemplary application includes marking of a broadcast stream with an identifier of the broadcaster that allows automated audience measurement. In audience measurement applications, embedded watermarks in a content that is being presented at a user location are detected. The detection of watermarks (e.g., via a personalized user device) allows various audience measurement metrics, such as the program identification, duration of exposure, number of exposures to a particular user, etc., to be measured. Any of the above described embodiments that use a blind watermark detection scheme provide a suitable solution for this application since it may not be convenient to provide some or all of the content objects for implementing a non-blind watermark detection scheme at a user device.

Another exemplary application relates to marking the sound component of a videogame played on a first device to enable a second device to detect and respond to the game in a synchronized fashion. This application can be more suitably enabled using the disclosed embodiments that use a blind watermark detection scheme.

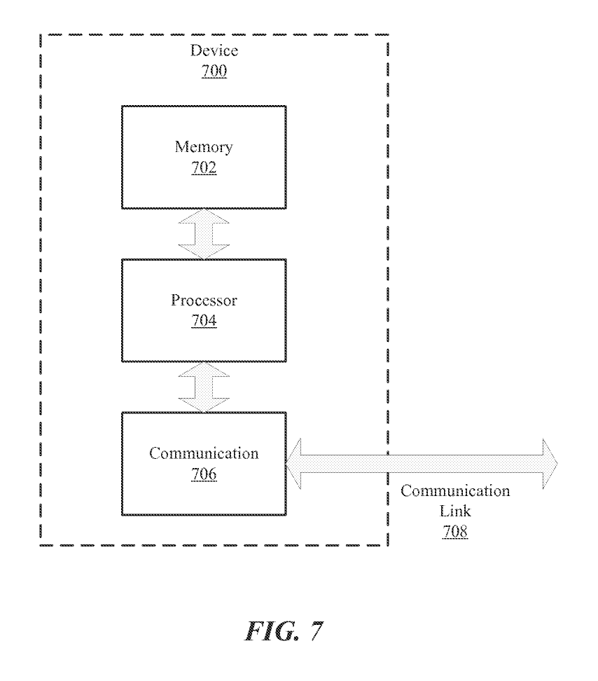

In some examples, the devices that are described in the present application can comprise a processor, a memory unit, and an interface that are communicatively connected to each other, and may range from desktop and/or laptop computers, to consumer electronic devices such as media players, mobile devices and the like. For example, FIG. 7 illustrates a block diagram of a device 700 within which various disclosed embodiments may be implemented. The device 700 comprises at least one processor 702 and/or controller, at least one memory 704 unit that is in communication with the processor 702, and at least one communication unit 706 that enables the exchange of content, data and information, directly or indirectly, through the communication link 708 with other entities, devices, databases and networks. The communication unit 706 may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. The exemplary device 700 that is depicted in FIG. 7 may be integrated into as part of a content handling device that can receive a content and conduct the various operations that are described in the present application, such as those operations illustrated in FIGS. 2-5.

It is understood that the various disclosed embodiments can be implemented individually, or collectively, in devices comprised of various hardware and/or software modules and components, or as a combination of hardware and software. In particular embodiments, a hardware implementation can include discrete analog and/or digital circuits that are, for example, integrated as part of a printed circuit board Alternatively, or additionally, in particular embodiments, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application.

In describing the disclosed embodiments, sometimes separate components have been illustrated as being configured to carry out one or more operations. It is understood, however, that two or more of such components can be combined together and/or each component may comprise sub-components that are not depicted. Further, the operations that are described in various figures of the present application are presented in a particular sequential order in order to facilitate the understanding of the underlying concepts. It is understood, however, that such operations may be conducted in a different sequential order, and further, additional or fewer steps may be used to carry out the various disclosed operations.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method for embedding a watermark message in an object-based composite content, comprising:
designating a plurality of content objects for carrying the watermark message comprising one or more watermark symbols in the composite object-based content that is generated according to an object-based encoding scheme;
obtaining a mapping of each watermark symbol to a temporal or spatial position of one or more of the designated content objects in the composite content; and
embedding each watermark symbol by including each of the one or more of the designated content objects in the composite content in conformance with the temporal or spatial relationship provided by the mapping.

2. The method of claim 1, wherein the mapping provides a mapping of a starting point of the one or more designated content objects for each of the watermark symbols.

3. The method of claim 1, wherein the mapping provides a mapping of a relative temporal or spatial distance between two or more of the designated content objects for each of the watermark symbols.

4. The method of claim 1, wherein the mapping provides a mapping for each possible watermark symbol value to a distinct temporal or spatial position of one or more of the designated content objects.

5. The method of claim I, wherein designating the plurality of content objects for carrying the watermark message includes identifying the plurality of content objects that carry at least part of the watermark message, and wherein the identified plurality of content objects are required for enabling detection of the embedded watermark message at a watermark detector device.

6. The method of claim 1, wherein:
designating the plurality of content objects for carrying the watermark message includes embedding an identification watermark into each of the plurality of content objects that are used to carry at least part of the watermark message; and
upon detection of the identification watermark at a watermark detector device, content objects that are used to carry at least part of the watermark message are identified so as to enable detection of the watermark message based on the identified content objects and the mapping of each watermark symbol to the temporal or spatial position of one or more of the identified content objects.

7. The method of claim , wherein the mapping is provided as a mapping table.

8. The method of claim 1, wherein the mapping is provided as an algorithm.

9. A method for embedding a watermark message comprising one or more watermark symbols in a content that is generated according to an object-based encoding scheme, the method comprising:
identifying a plurality of content objects for carrying the watermark message in a composite object-based content;
for each identified content object, generating at least one alternate version of the identified content object so as to allow all values of a watermark symbol to be represented by each of the identified content objects or an alternate version thereof; and
embedding each water/mark symbol by choosing one, but not both, of a particular content object or an alternate version of the particular content object, and including the chosen one of the content object or the alternate version in the composite content.

10. The method of claim 9, wherein the watermark symbols are binary symbols and choosing one, but not both, of the particular content object or the alternate version includes one, but not both, of:
(a) choosing the particular content object to represent a binary value of zero and choosing the alternate version of the particular content object to represent a binary value of one; or
(b) choosing the particular content object to represent a binary value of one and choosing the alternate version of the particular content object to represent a binary value of zero.

11. The method of claim 9, wherein a first alternate version is generated by embedding a first watermark in the particular content object, and a second alternate object is generated by embedding a second watermark that is different from the first watermark in the particular content object.

12. A device, comprising:
a processor; and
a memory comprising program code, the program code when executed by the processor, causes the device to:
designate a plurality of content objects for carrying a watermark message comprising one or more watermark symbols in a composite object-based content that is generated according to an object-based encoding scheme;
obtain a flapping of each watermark symbol to a temporal or spatial position of one or more of the designated content objects in the composite content; and
embed each watermark symbol by including each of the one or more of the designated content objects in the composite content in conformance with the temporal or spatial relationship provided by the mapping.

13. The device of claim 12, wherein the mapping provides a mapping of a starting point of the one or more designated content objects for each of the watermark symbols.

14. The device of claim 12, wherein the mapping provides a mapping of a relative temporal or spatial distance between two or more of the designated content objects for each of the watermark symbols.

15. The device of claim 12, wherein the mapping provides a mapping for each possible watermark symbol value to a distinct temporal or spatial position of one or more of the designated content objects.

16. The device of claim 12, wherein the program code when executed by the processor, causes the device to designate the plurality of content objects for carrying the watermark message by at least in-part identification of the plurality of content objects that carry at least part of the watermark message, wherein the identified plurality of content objects are required for enabling detection of the embedded watermark message at a watermark detector device.

17. The device of claim 12, the program code when executed by the processor, causes the device to designate the plurality of content objects for carrying the watermark message by at least in-part embedding an identification watermark into each of the plurality of content objects that are used to carry at least part of the watermark message, wherein upon detection of the identification watermark at a watermark detector device, content objects that are used to carry at least part of the watermark message are identified so as to enable detection of the watermark message based on the identified content objects and the mapping of each watermark symbol to the temporal or spatial position of one or more of the identified content objects.

18. The device of claim 12. Therein the memory includes a mapping table that provides the mapping.

19. The device of claim 12, wherein the mapping is provided as an algorithm that is executed by the processor.

20. A device, comprising:
a processor; and
a memory comprising program code, the program code when executed by the processor, causes the device to:
identify a plurality of content objects for carrying a watermark message comprising one or more watermark symbols in a composite object-based content that is generated according to an object-based encoding scheme;
for each identified content object, generate at least one alternate version of the identified content object so as to allow all values of a watermark symbol to be represented by each of the identified content objects or an alternate version thereof;
embed each watermark symbol by choosing one, but not both, of a particular content object or an alternate version of the particular content object, and include the chosen one of the content object or the alternate version in the composite content.

21. The device of claim 20, wherein the watermark symbols are binary symbols and choosing one, but not both, of the particular content object or the alternate version includes one, but not both, of:
(a) choosing the particular content object to represent a binary value of zero and choosing the alternate version of the particular content object to represent a binary value of one; or
(b) choosing the particular content object to represent a binary value of one and choosing the alternate version of the particular content object to represent a binary value of zero.

22. The device of claim 20, wherein the program code when executed by the processor, causes the device to generate a first alternate version by embedding a first watermark in the particular content object, and generate a second alternate object by embedding a second watermark that is different from the first watermark in the particular content object.

23. A computer program product,embodied on one or more non-transitory computer readable media, comprising:
program code for designating a plurality of content objects for carrying a watermark message comprising one or more watermark symbols in a composite object-based content that is generated according to an object-based encoding scheme;
program code for obtaining a mapping of each watermark symbol to a temporal or spatial position of one or more of the designated content objects in the composite content; and
program code for embedding each watermark symbol by including each of the one or more of the designated content objects in the composite content in conformance with the temporal or spatial relationship provided by the mapping.

24. A computer program product, embodied on one or more non-transitory computer readable media, comprising:
program code for identifying plurality of content objects for carrying a watermark message comprising one or more watermark symbols in a composite object-based content that is generated according to an object-based encoding scheme;
program code for, for each identified content object, generating at least one alternate version of the identified content object so as to allow all values of a watermark symbol to be represented by each of the identified content objects or an alternate version thereof;
program code for embedding each watermark symbol by choosing one, but not both, of a particular content object or an alternate version of the particular content object, and including the chosen one of the content object or the alternate version in the composite content.

25. A method for detecting a watermark message from a composite content, the method comprising:
receiving the composite content that includes the watermark message comprising one or more watermark symbols, the composite content having been generated according to an object-based encoding scheme;
obtaining a plurality of content objects, each of the plurality of content objects designated as including at least part of the watermark message that is embedded in the composite content;
obtaining a mapping of watermark symbols to temporal or spatial positions of the plurality of content objects in the composite content, the mapping including a mapping of each watermark symbol value to a particular temporal or spatial position of one or more of the plurality of content objects; and
using the mapping and the plurality of content objects to discern one or more watermark symbols of the watermark message included in the composite content based on the temporal or spatial positions of the plurality of content objects in the composite content.

26. The method of claim 25, wherein using the mapping and the plurality of content objects to discern the one or more watermark symbols of the watermark message includes:
correlating a first of the plurality of content objects with the composite content to locate the position of the first of the plurality of content objects in the composite content; and
using the mapping to determine the value of a first watermark symbol embedded in the composite content based on the temporal or spatial position of the first of the plurality of content objects in the composite content.

27. A method for detecting a watermark message from a composite content, the method comprising:
receiving the composite content that includes the watermark message comprising one or more watermark symbols, the composite content having been generated according to an object-based encoding scheme and including a plurality of content objects;
detecting identification watermarks from the received composite content, each identification watermark identifying (a) a content object that is used to carry at least part of the embedded watermark message in the composite content, and (b) a temporal or a spatial position of the content object in the composite content;
obtaining a mapping of watermark symbols to temporal or spatial positions of the plurality of content objects in the composite content, the mapping including a mapping of each watermark symbol value to a particular temporal or spatial position of one or More/, of the plurality of content objects; and
using the mapping to discern one or more watermark symbols of the watermark message included in the composite content based on the temporal or spatial positions of the identified content objects and the temporal or spatial positions of the identified content objects in the composite content.

28. The method of claim 27, wherein identifying the temporal or a spatial position of the content object in the composite content includes identifying a starting location of the content object in the composite content.

29. The method of claim 27, wherein identifying the temporal or a spatial position of the content object in the composite content includes identifying a relative location of the of the content object with respect to another content object in the composite content.

30. The method of claim 27, wherein the identification information conveys information regarding a sequential order of watermark symbols of the watermark message.

31. A device, comprising:
a processor; and
a memory comprising program code, the program code when executed by the processor causes the device to:
receive a composite content, the composite content having been generated according to an object-based encoding scheme;
obtain a plurality of content objects, each of the plurality of content objects designated as including at least part of a watermark message comprising one or more watermark symbols embedded in the composite content;
obtain a mapping of watermark symbols to temporal or spatial positions of the plurality of content objects in the composite content, the mapping including a mapping of each watermark symbol value to a particular temporal or spatial position of one or more of the plurality of content objects; and
discern the watermark symbols of the watermark message included in the composite content using the mapping and the plurality of content objects and based on the temporal or spatial positions of the plurality of content objects in the composite content.

32. The device of claim 31, wherein to discern the watermark symbols of the watermark message, the program code when executed by the processor causes the device to at least:
correlate a first of the plurality of content objects with the composite content to locate the position of the first of the plurality of content objects in the composite content; and
use the mapping to determine the value of a first watermark symbol embedded in the composite content based on the temporal or spatial position of the first of the plurality of content objects in the composite content.

33. A device, comprising:
a processor; and
a memory comprising program code, the program code when executed by the processor causes the device to:
receive a composite content that includes a watermark message comprising one or more watermark symbols, the composite content having been generated according to an object-based encoding scheme and including a plurality of content objects;
detect identification watermarks from the received composite content, each identification watermark identifying (a) a content object that is used to carry at least part of the embedded watermark message in the composite content, and (b) a temporal or a spatial position of the content object in the composite content;
obtain a mapping of watermark symbols to temporal or spatial positions of the plurality of content objects in the composite content, the mapping including a mapping of each watermark symbol value to a particular temporal or spatial position of one or more of the plurality of content objects; and
use the mapping to discern the one or more watermark symbols of the watermark message included in the composite content based on the temporal or spatial positions of the identified content objects and the temporal or spatial positions of the identified content objects in the composite content.

34. The device of claim 33, wherein o identify the temporal or a spatial position of the content object in the composite content, the program code when executed by the processor causes the device to at least identify a starting location of the content object in the composite content.

35. The method of claim 33, wherein to identify the temporal or a spatial position of the content object in the composite content, the program code when executed by the processor causes the device to at least identify a relative location of the of the content object with respect to another content object in the composite content.

36. The method of claim 33, wherein the identification information conveys information regarding a sequential order of watermark symbols of the watermark message.

37. A computer program product, embodied on one or more non-transitor computer readable media, comprising:
program code for receiving the composite content that includes a watermark message comprising one or more watermark symbols, the composite content having been generated according to an object-based encoding scheme;
program code for obtaining a plurality of content objects, each of the plurality of content objects designated as including at least part of the watermark message that is embedded in the composite content;
program code for obtaining a mapping of watermark symbols to temporal or spatial positions of the plurality of content objects in the composite content, the mapping including a mapping of each watermark symbol value to a particular temporal or spatial position of one or more of the plurality of content objects; and
program code for using the mapping and the plurality of content objects to discern the one or more watermark symbols of the watermark message included in the composite content based on the temporal or spatial positions of the plurality of content objects in the composite content.

38. A computer program product, embodied on one or more non-transitory computer readable media, comprising:
program code for receiving the composite content that includes a watermark message comprising one or more watermark symbols, the composite content having been generated according to an object-based encoding scheme and including a plurality of content objects;
program code for detecting identification watermarks from the received composite content, each identification watermark identifying (a) a content object that is used to carry at least part of the embedded watermark message in the composite content, and (h) a temporal or a spatial position of the content object in the composite content;
program code for obtaining a mapping of watermark symbols to temporal or spatial positions of the plurality of content objects in the composite content, the mapping including a. mapping of each watermark symbol value to a particular temporal or spatial position of one or more of the plurality of content objects; and
program code for using the mapping to discern the one or more watermark symbols of the watermark message included in the composite content based on the temporal or spatial positions of the identified content objects and the temporal or spatial positions of the identified content objects in the composite content.

39. A device, implemented at least partially in hardware, comprising:
a content object selector to receive a plurality of content objects and to designate a subset of the plurality of content objects for carrying a watermark message comprising one or more watermark symbols;
a watermark symbol flapping generator to obtain a mapping of each watermark symbol to a temporal or spatial position of one or more of the designated content objects in a composite object-based content that is generated according to an object-based encoding scheme;
a watermark symbol generator to generate the plurality of watermark symbols for embedding into the composite object-based content; and
a renderer coupled to the content object selector, the watermark symbol mapping generator and the watermark symbol generator to embed the watermark symbols provided by the watermark symbol generator by including each of the one or more of the designated content objects identified by the content object selector in the composite object-based content output by the renderer in conformance with the temporal or spatial relationship provided by the watermark symbol mapping generator.

40. A device, implemented at least partially in hardware, comprising:
a content object selector to receive a plurality of content objects and to designate a. subset of the plurality of content objects for carrying a watermark message comprising one or more watermark symbols;
a watermark symbol generator to generate the plurality of watermark symbols for embedding into the composite object-based. content;
a watermark embedder coupled to the content object selector to receive each of the designated content objects and to generate at least one alternate version of the designated content object so as to allow all values of a watermark symbol to be represented by each of the identified content objects or an alternate version thereof; and
a renderer coupled to the watermark embedder, the watermark symbol mapping generator and the watermark symbol generator to embed the watermark symbols provided by the watermark symbol generator by choosing one, but not both, of designated content objects or alternate versions thereof provided by the watermark embedder in the composite object-based content output by the renderer in conformance with the temporal or spatial relationship provided by the watermark symbol mapping generator.

41. A device, implemented at least partially in hardware, comprising:
a receiver to receive (a) a composite content that includes a watermark message comprising one or more watermark symbols, the composite content having been generated according lo an object-based encoding scheme, (b) a plurality of content objects, each of the plurality of content objects designated as including at least part of the watermark message that is embedded in the composite content, and (c) a mapping of watermark symbols to temporal or spatial positions of the plurality of content objects in the composite content, the mapping including a mapping of each watermark symbol value to a particular temporal or spatial position of one or more of the plurality of content objects; and
a content object identifier coupled to the receiver to use the mapping and the plurality of content objects to identify temporal or spatial positions of the plurality of content objects in the received composite content; and
a watermark symbol detector coupled to the content object identifier to discern one or more watermark symbols of the watermark message included in the composite content based on the temporal or spatial positions of the plurality of content objects in the composite content in accordance with the mapping.

42. A device, implemented at least partially in hardware, comprising:
a receiver to receive (a) a composite content that includes a watermark message comprising one or more watermark symbols, the composite content having been generated according to an object-based encoding scheme and including a plurality of content objects, and (b) a mapping of watermark symbols to temporal or spatial positions of the plurality of content objects in the composite content, the mapping including a mapping of each watermark symbol value to a particular temporal or spatial position of one or more of the plurality of content objects; and
an identification watermark extractor coupled to the receiver to detect identification watermarks from the received composite content, each identification watermark identifying (a) a content object that is used to carry at least part of the embedded watermark message in the composite content, and (b) a temporal or a spatial position of the content object in the composite content;
a watermark symbol detector coupled to the content object identifier and to the receiver to discern one or more watermark symbols of the watermark message included in the composite content based on the temporal or spatial positions of the plurality of content objects in the composite content in accordance with the mapping.
